(19) United States
(12) Patent Application Publication
(10) Pub. No.: US 2025/0017148 A1
(43) Pub. Date: Jan. 16, 2025

(54) Plant Pot Hanger

(71) Applicant: IWPH Company, Hannon (CA)

(72) Inventor: Richard D. Clark, Hannon (CA)

(21) Appl. No.: 18/903,968

(22) Filed: Oct. 1, 2024

Related U.S. Application Data
(63) Continuation-in-part of application No. 17/368,606, filed on Jul. 6, 2021, now Pat. No. 12,102,250.
(60) Provisional application No. 63/048,572, filed on Jul. 6, 2020.

(51) Int. Cl. A01G 9/02

(52) U.S. Cl. CPC A01G 9/024

(57) ABSTRACT

A plant pot hanger has three or more cables, each of which cables have a first end and a second end, and wherein the three or more cables are secured together at the first ends of the respective cables. A sliding loop is formed at the second end of each respective cable. Each cable is threaded through the sliding loop of a respective adjacent cable to form a ring adaptable for running under a rim of a plant pot and supporting the plant pot. A loop or a hook for hanging the plant pot preferably extends from the respective first ends of the three or more cables. The three or more cables are preferably run through a slide collar which is slid downwardly, thereby reducing the angle of the cables from horizontal, and reducing the swing and spin of the plant pot hanger in wind.

### CROSS-REFERENCE TO RELATED APPLICATIONS

This application is a continuation-in-part of U.S. Pat. No. 12,102,250, formerly co-pending patent application Ser. No. 17/368,606, filed on Jul. 6, 2021, and issued on Oct. 1, 2024, and claims the benefit of U.S. Provisional Application No. 63/048,572, filed Jul. 6, 2020, both of which applications are hereby incorporated herein by reference, in their entirety.

### TECHNICAL FIELD

The invention relates generally to a plant pot hanger.

### BACKGROUND

Conventionally, plant pots are held in non-descript pot hangers that operate in different manners and different configurations. A problem with such pot hangers is that they may not be durable or serviceable, may require different sizes and configurations of pot hangers, and may be bulky and aesthetically unpleasing. Further, many pot hangers are, in wind, susceptible to swinging or “spinning” about a vertical axis extending through the pot hanger.

Therefore, what is needed is an apparatus and method for providing an efficient but pleasant-looking support that is well-placed and adjustable, as well as durable, malleable and compact, and which reduces swinging or spinning in wind.

A solution would be an apparatus and method that is durable, serviceable, malleable, aesthetically pleasing, compact, resistant to reduces swinging or spinning in wind, and that accommodates different sizes of pots, and without causing undesirable visual effects or otherwise detracting from the overall decorative effect desired.

### SUMMARY

The present invention, accordingly, provides a plant pot hanger having three or more cables, each of which cables have a first end and a second end, and wherein the three or more cables are secured together at the first ends of the respective cables. A sliding loop is formed at the second end of each respective cable. Each cable is threaded through the sliding loop of a respective adjacent cable to form a ring adaptable for running under a rim of a plant pot and supporting the plant pot. A loop or a hook for hanging the plant pot preferably extends from the respective first ends of the three or more cables.

In a plant pot hanger having a first cable and a second cable, the second cable is configured to form a top loop and a third cable. The first, second, and third cables and top loop are secured by a ferrule, wherein the top loop extends through the top end of the ferrule, and the first, second, and third cables extend through the bottom end of the ferrule. A sliding loop is secured at an end of each respective cable, and wherein the first cable is threaded through the sliding loop of the third cable, the second cable is threaded through the sliding loop of the first cable, and the third cable is threaded through the sliding loop of the second cable, to form a tri-sector ring adaptable for running under a rim of a plant pot and supporting the plant pot. Cable locks are preferably used for securing the respective sliding loop at an end of each respective cable.

In a refinement of the plant pot hanger, the cables are run through a slide collar. The slide collar is slid downwardly to reduce an angle of the cables from horizontal. In an unexpected consequence, such lowering of the slide collar reduced the swing and spin of the plant pot hanger in wind, thereby rendering a significant advantage to at least one embodiment of the invention over conventional plant pot hangers.

The foregoing has outlined rather broadly the features and technical advantages of the present invention in order that the detailed description of the invention that follows may be better understood. Additional features and advantages of the invention will be described hereinafter which form the subject of the claims of the invention. It should be appreciated by those skilled in the art that the conception and the specific embodiment disclosed may be readily utilized as a basis for modifying or designing other structures for carrying out the same purposes of the present invention. It should also be realized by those skilled in the art that such equivalent constructions do not depart from the spirit and scope of the invention as set forth in the appended claims.

### BRIEF DESCRIPTION OF THE DRAWINGS

For a more complete understanding of the present invention, and the advantages thereof, reference is now made to the following descriptions taken in conjunction with the accompanying drawings, in which:

FIG. 1 is a perspective view of a plant pot hanger according to one preferred embodiment of the present invention;

FIG. 2 is a bottom view of the plant pot hanger of FIG. 1, as viewed pursuant to line 2-2 of FIG. 1;

FIG. 3 exemplifies a sliding loop of the plant pot hanger of FIG. 1;

FIG. 4 exemplifies a ferrule used to form a hanging loop for hanging the plant pot hanger of FIG. 1, and for attaching it to a hook;

FIG. 5 exemplifies an alternate embodiment of a ferrule used to form a hanging loop for hanging the plant pot hanger of FIG. 1, and for attaching it to a hook;

FIG. 6 exemplifies the embodiments of FIGS. 1-5 further comprising tubing through which portions of cables that engage a plant pot are run;

FIG. 7 depicts a cross-section of cable running through tubing in accordance with principles of the invention, the cross-section being taken along line 7-7 of FIGS. 6 and 10;

FIG. 8 exemplifies an alternate embodiment of a plant pot hanger assembly utilizing four cables in accordance with principles of the invention;

FIG. 9 exemplifies a ferrule used to form a hanging loop for hanging the plant pot hanger of FIG. 8, and for attaching it to a hook;

FIG. 10 exemplifies the embodiments of FIGS. 8 and 9 further comprising tubing through which portions of cables that engage a plant pot are run;

FIG. 11 exemplifies an alternate embodiment of the plant pot hanger of FIG. 1 utilizing a slide collar;

FIG. 12 exemplifies an alternate embodiment of the plant pot hanger of FIG. 6 utilizing a slide collar;

FIG. 13 exemplifies an alternate embodiment of the plant pot hanger of FIG. 8 utilizing a slide collar;

FIG. 14 exemplifies an alternate embodiment of the plant pot hanger of FIG. 10 utilizing a slide collar;

FIG. 15 exemplifies cross-sectional detail of the slide collar utilized in the embodiments of FIGS. 11-14; and

FIGS. 16-19 exemplify cross-sectional detail of alternate embodiments of the slide collars of FIG. 15.

### DETAILED DESCRIPTION

Refer now to the drawings wherein like or similar elements are designated by the same reference numeral through the several views. The following description is presented to enable any person skilled in the art to make and use the invention, and is provided in the context of a particular application and its requirements. Various modifications to the disclosed embodiments will be readily apparent to those skilled in the art, and the general principles defined herein may be applied to other embodiments and applications without departing from the spirit and scope of the present invention. Thus, the present invention is not intended to be limited to the embodiments shown, but is to be accorded the widest scope consistent with the principles and features disclosed herein. Additionally, as used herein, the term “substantially” is to be construed as a term of approximation.

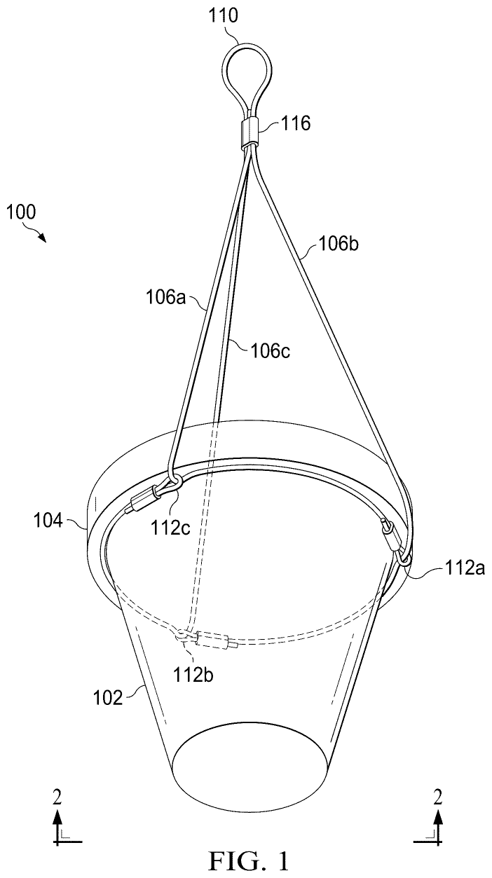

Referring to FIG. 1 of the drawings, the reference numeral 100 generally designates a plant pot hanger assembly comprising a plant pot 102 suspended by cables 106a, 106b and 106c (collectively referred to herein as cables 106) which run under a rim 104 formed in the upper circumference of plant pot 102 in accordance with one embodiment of the invention. Plant pot 102 is a conventional plant pot made in any conventional manner using conventional materials, such as clay, plastic, ceramic, or the like. Plant pots are considered to be well-known in the art, and so will not be described in further detail herein, except insofar as necessary to describe the invention.

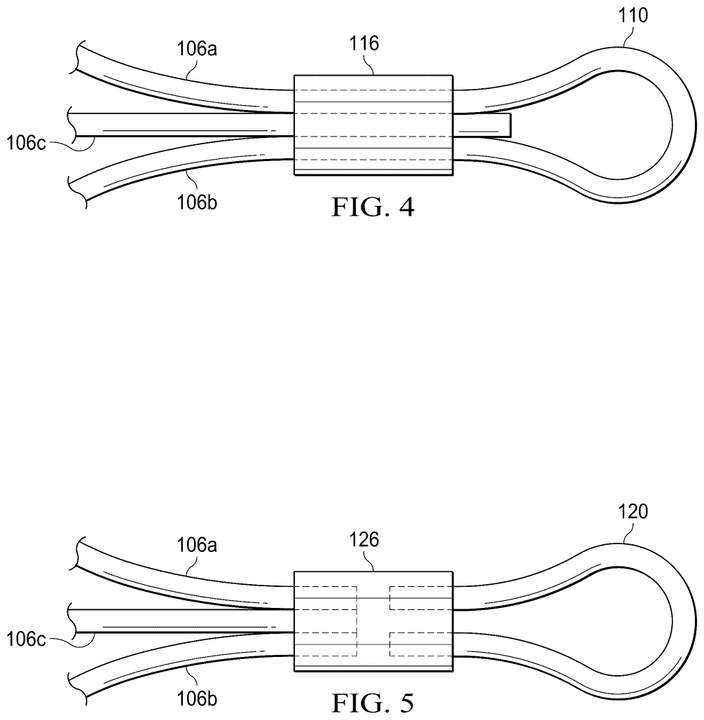

Cables 106 are preferably fabricated from 3/64″ diameter braided SAE 304 stainless steel aircraft cable, but may be of any suitable diameter fabricated from any suitable material, preferably corrosion resistant material, including, by way of example but not limitation, wires, carbon fiber, nylon, plastic, or the like. As shown most clearly in FIGS. 1 and 4, cables 106 are preferably secured together at an upper end with a ferrule 116, though other means may be used, such as tack welding, epoxy, and the like. Two cables 106a and 106b preferably constitute a single cable which is preferably configured to form a hanging loop 110 or hook for suspending plant pot 102 from a further hook or other mounting support (not shown). Ferrule 116 is preferably made from aluminum, but may be made from any suitable material.

As shown most clearly in FIGS. 1-3, at a lower end of each of cables 106a, 106b and 106c, a respective sliding loop 112a, 112b and 112c is formed and secured thereto with a respective cable lock 114a, 114b and 114c. Alternatively, the sliding loops may be secured to respective ends using ferrules, tack welding, epoxy, or the like.

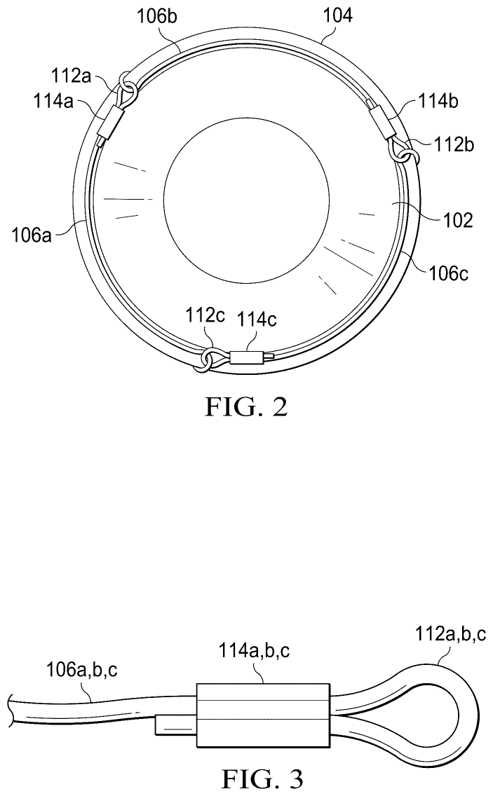

FIGS. 1 and 2 show how cables 106a, 106b and 106c, and respective sliding loops 112a, 112b and 112c, are interconnected to form a ring under rim 104 for supporting plant pot 102. More specifically, cable 106a extends downwardly from ferrule 116 to rim 104, through sliding loop 112c, and then about one third of the circumference (˜120°) under rim 104. Similarly, cable 106b extends downwardly from ferrule 116 to rim 104, through sliding loop 112a, and then about a further one third of the circumference (˜120°) of the pot under rim 104. Finally, cable 106c extends downwardly from ferrule 116 to rim 104, through sliding loop 112b, and then about a further one third of the circumference (˜120°) of the pot under rim 104. As best viewed in FIG. 1, it can be appreciated that cables 106 form a tri-sector ring under rim 104 that automatically adjusts to the diameter of the rim as pot plant 102 is suspended from the cables.

In a preferred method of use, cables 106 are laid out on a flat surface, such as the ground or a table, so that some semblance of a triangle is formed. A plant pot 102 is placed in the triangle. The cables are then pulled upwardly while being tightened under rim 104. Hanging loop 110 is then placed over a hook (not shown) to thereby support plant pot 102.

FIG. 5 depicts an alternate preferred embodiment of the present invention whereby cable portions 106a and 106b are separate cables rather than a single longer cable. Each of cables 106 have ends that securely terminate in one end of a ferrule 126. A loop 120 or other suitable means (e.g., a hook) is secured to the other end of ferrule 126 for suspending the plant pot holder. Operation of the plant pot hanger of FIG. 5 is substantially similar to operation of the plant pot hanger of FIGS. 1-4.

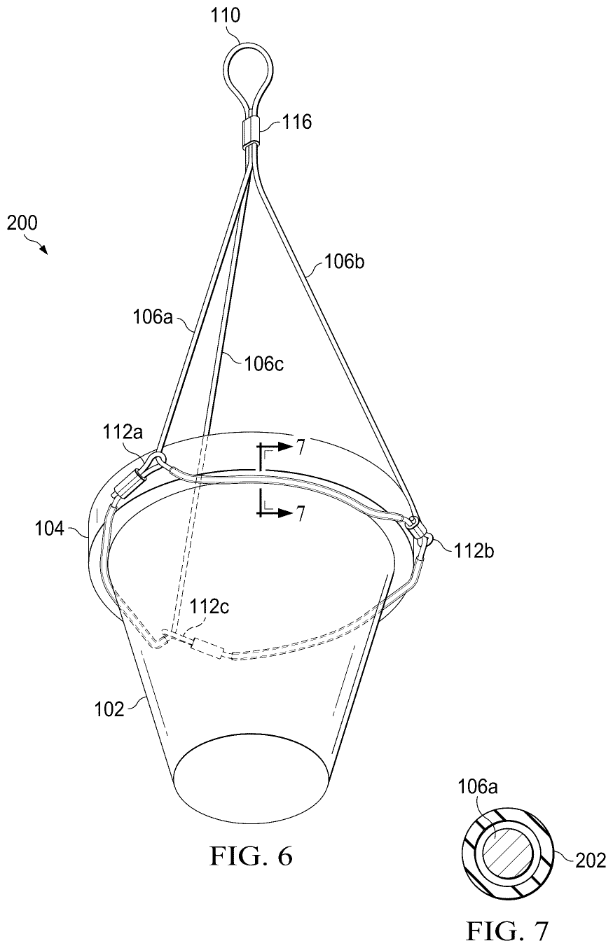

FIGS. 6 and 7 depict an alternate embodiment of a plant pot hanger assembly 200 similar to plant pot hanger assembly 100 of FIGS. 1-5. In addition to the elements and features of the assembly 100, assembly 200 further includes tubing 202 through which portions of cables 106 that engage and support plant pot 102 under rim 104 are run. Tubing 202 is preferably made from silicon, though it may be made from any suitable material (e.g., a poly plastic such as polyethylene, polypropylene, and other polymers). Tubing 202 is further preferably cut to a desirable length, such as three to six inches. By incorporating tubing 202 into assembly 200, cables 106 can support plant pot 102 more securely with a better grip. Further, when preparing to use the cables 106 to support plant pot 102, cables 106 with tubing 202 make a better triangle in which to place plant pot 102 prior to pulling the cables upwardly while tightening the cables around plant pot 102 and under rim 104.

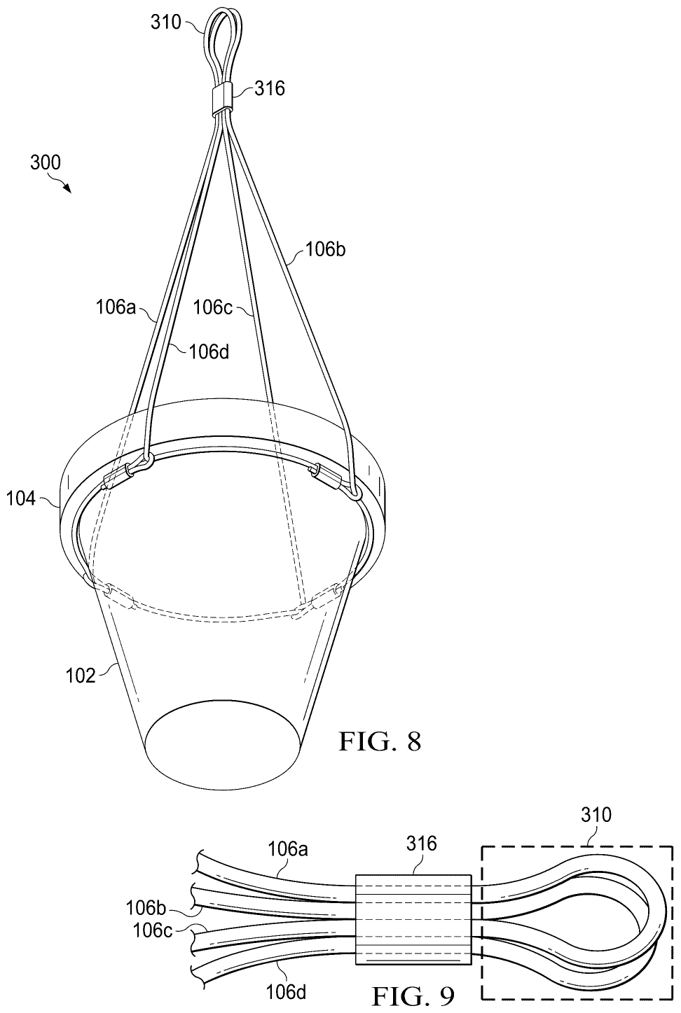

FIGS. 8 and 9 exemplify an alternate embodiment 300 of the plant pot hanger of FIGS. 1-5 wherein a fourth cable 106d is modeled in addition to cables 106a, 106b, and 106c. Cables 106a and 106c are preferably paired to constitute two halves of a first cable (not shown as such) folded above a ferrule 316 or the like to form a first half of a hanging loop 310. Similarly, cables 106b and 106d are preferably paired to constitute two halves of a second cable (not shown as such) folded above the ferrule 316 to form a second half of the hanging loop 310. Alternately, cables 106a and 106b could be paired and cables 106c and 106c could be paired.

At each end of each of cables 106a, 106b, 106c, and 106d, a respective sliding loop 112a, 112b, 112c, and 112d is formed and secured thereto with a respective cable lock 114a, 114b, 114c, and 114d. Alternatively, the sliding loops may be secured to respective ends using ferrules, tack welding, epoxy, or the like.

Cables 106a, 106b, 106c, and 106d and respective sliding loops 112a, 112b, 112c, and 112d are interconnected to form a ring under rim 104 for supporting plant pot 102, similarly as described above with respect to FIGS. 1 and 2. Generally, each cable 106 is threaded through the sliding loop 112 of a respective adjacent cable to form a ring adaptable for running under rim 104 of plant pot 102 and supporting the plant pot.

In a preferred method of use, cables 106 are laid out on a flat surface, such as the ground or a table so that some semblance of a square is formed. A plant pot 102 is placed in the square. The cables are then pulled upwardly while being tightened under rim 104. Hanging loop 310 is then placed over a hook (not shown) to thereby support plant pot 102.

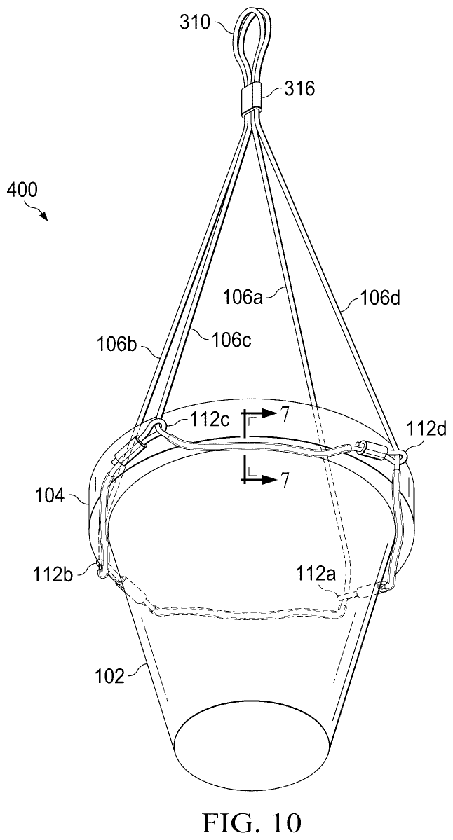

FIG. 10 depicts an alternate embodiment of a plant pot hanger assembly 400 similar to plant pot hanger assembly 300 of FIGS. 8 and 9. As similarly discussed above with respect to FIGS. 6 and 7, in addition to the elements and features of the assembly 300, assembly 400 further includes tubing 202 through which portions of cables 106 that engage and support plant pot 102 under rim 104 are run. By incorporating tubing 202 into assembly 400, cables 106 can support plant pot 102 more securely with a better grip. Further, when preparing to use the cables 106 to support plant pot 102, cables 106 with tubing 202 make a better square in which to place plant pot 102 prior to pulling the cables upwardly while tightening the cables around plant pot 102 and under rim 104.

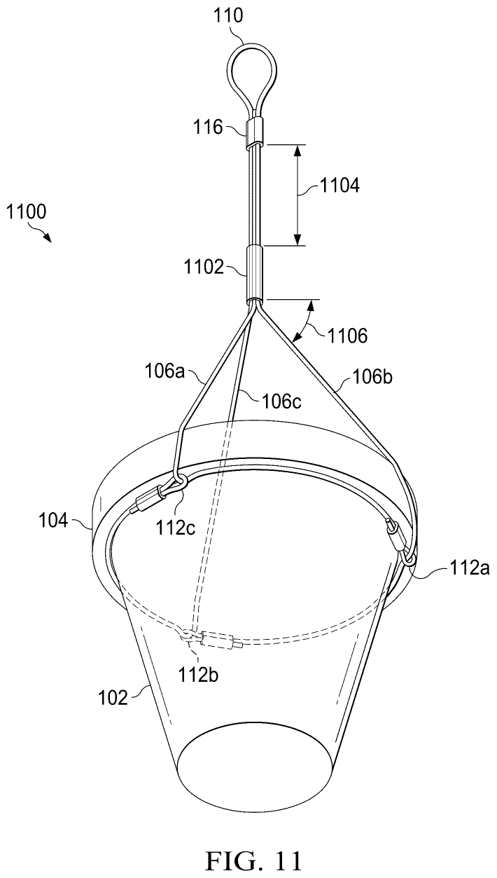

FIG. 11 exemplifies an alternate embodiment 1100 of the plant pot hanger assembly 100 of FIG. 1. Accordingly, plant pot hanger assembly 1100 includes a slide collar 1102 through which cables 106a, 106b, and 106c extend. In operation, slide collar 1102 is preferably slid downwardly until a mild resistance to further downward sliding is met, exemplified at a distance 1104, depicted as about halfway between ferrule 116 or 316 and the top of rim 104. The downward slide of slide collar 1102 also has the effect of reducing an angle 1106 defined between horizontal and any of cables 106a, 106b, and 106c. Surprisingly, it has been found that as slide collar 1102 is slid downwardly, the resistance of the plant pot hanger to swing and spin in wind is increased. Also surprisingly, slide collar 1102 holds its position on cables 106a, 106b, and 106c, resisting pressure from the cables to move upwards. Slide collar 1102 also permits a one-size plant pot hanger assembly to fit a wide variety of sizes of plant pots 102.

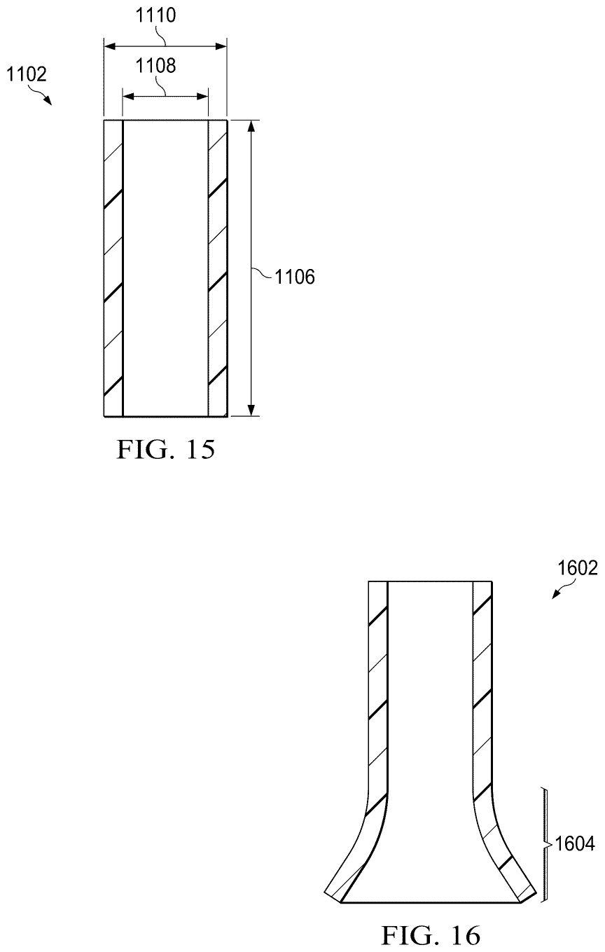

Slide collar 1102 is preferably made from silicon (preferably surgical grade silicon), poly plastic (e.g., polyethylene, polypropylene, and other polymers), or any other suitable material. With respect to FIG. 15, slide collar 1102 is sized with a length 1106 sufficient for human fingers to readily grasp and slide it along the cables. Accordingly, length 1106 is typically between about 1 inch and about 2 inches, and preferably about 1.25 inches (nominally about 38 millimeters (‘mm”)). Slide collar 1102 is preferably sized with an inside diameter 1108 sufficient for cables 106a, 106b, and 106c to fit snugly. Accordingly, the inside diameter is preferably about 3 mm. The outside diameter is sized to secure the cables at the lower end of the collar 1102; accordingly, the outside diameter of collar 110 is preferably about 5 mm.

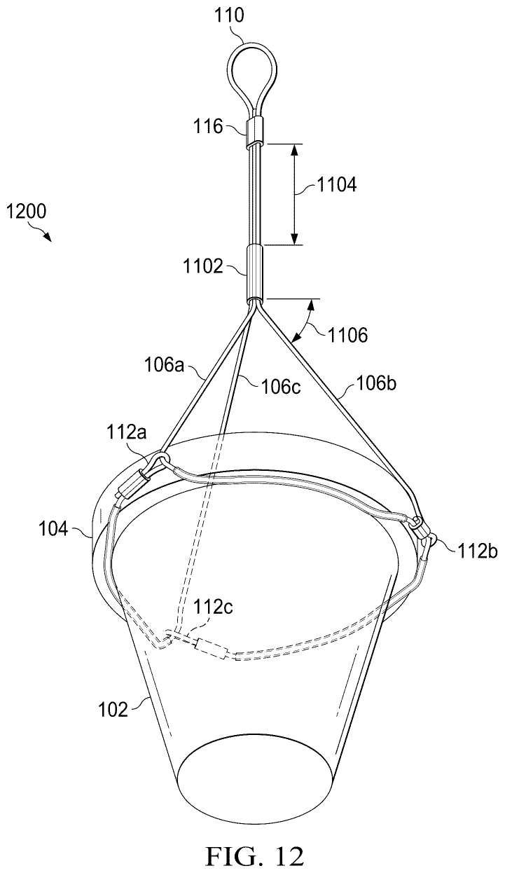

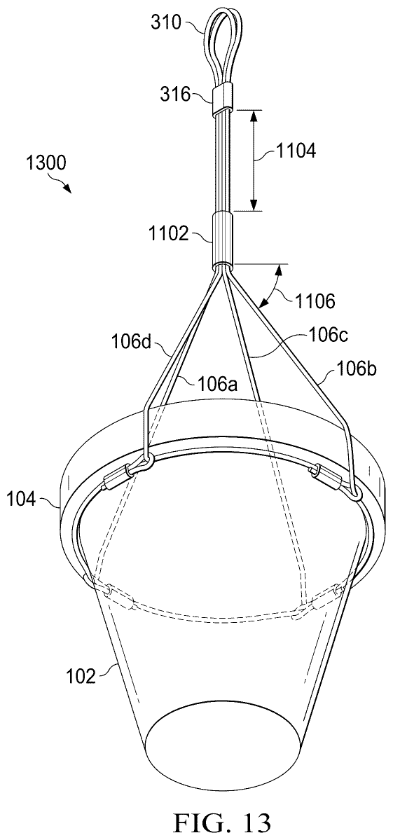

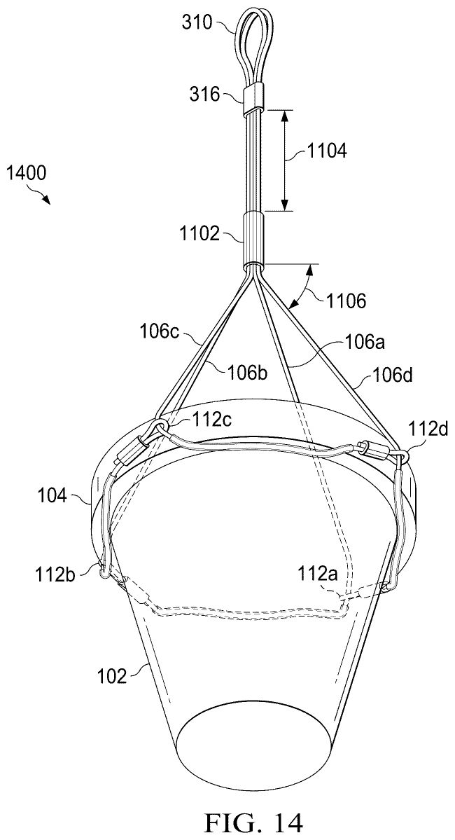

FIGS. 12-14 exemplify how slide collar 1102 can be fitted onto plant pot hanger assemblies 200, 300, and 400 of respective FIGS. 6, 8, and 10, depicted as plant pot hanger assemblies 1200, 1300, and 1400 of respective FIGS. 12, 13, and 14.

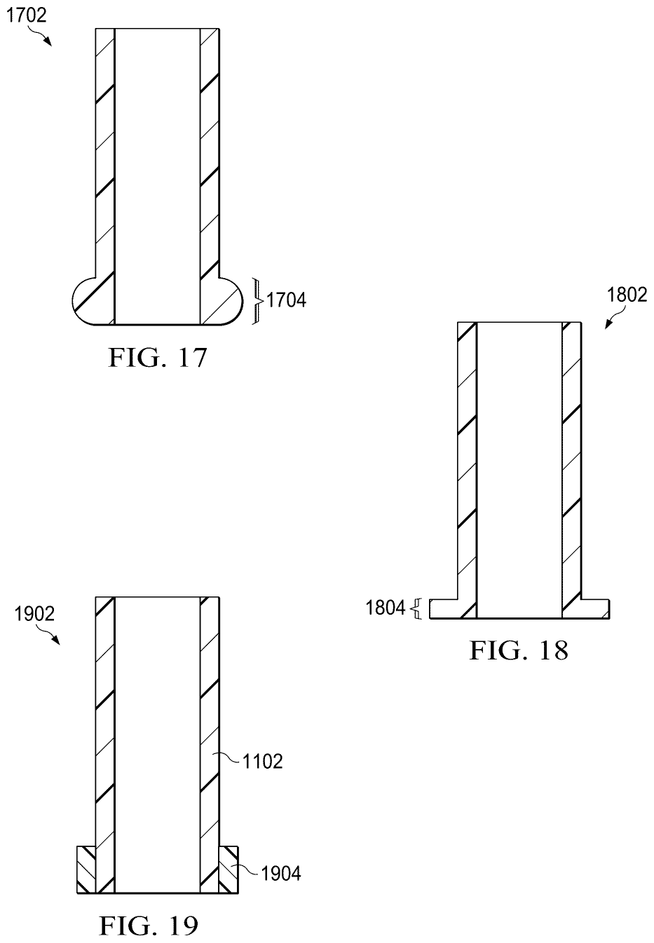

FIGS. 16-19 exemplify alternate embodiments of the slide collar 1102 of FIG. 15 that have reinforced lower ends to better secure the cables. Accordingly, by way of example and not limitation, FIG. 16 exemplifies an embodiment 1602 having a frustoconical lower end 1604. FIG. 17 exemplifies an embodiment 1702 having a bulbous lower end 1704. FIG. 18 exemplifies an embodiment 1802 having a flange-type lower end 1804. FIG. 19 exemplifies an embodiment 1902 having a banded lower end 1904, the band being fabricated from any suitable material, e.g., plastic, metal, or the like.

The use of the present invention provides a number of advantages over the prior art. For example, it is durable, serviceable, malleable, aesthetically pleasing, compact, accommodating of different sizes of pots, and without causing undesirable visual effects or otherwise detracting from the overall decorative effect desired. Still further, the slide collar reduces sway, swinging, and spinning of a plant pot in wind, and it allows for a one-size plant pot hanger assembly to fit a wide variety of sizes of plant pots.

It is understood that the present invention may take many forms and embodiments. Accordingly, several variations may be made in the foregoing without departing from the spirit or the scope of the invention. For example, more than three cables may be used in accordance with principles of the present invention.

Having thus described the present invention by reference to certain of its preferred embodiments, it is noted that the embodiments disclosed are illustrative rather than limiting in nature and that a wide range of variations, modifications, changes, and substitutions are contemplated in the foregoing disclosure and, in some instances, some features of the present invention may be employed without a corresponding use of the other features. Many such variations and modifications may be considered obvious and desirable by those skilled in the art based upon a review of the foregoing description of preferred embodiments. Accordingly, it is appropriate that the appended claims be construed broadly and in a manner consistent with the scope of the invention.

1. A plant pot hanger comprising:
a sliding collar;
three or more cables threaded through the sliding collar, each of which cables have a first end and a second end, wherein the three or more cables are secured together at the first ends of the respective cables;
wherein a sliding loop is formed at the second end of each respective cable; and
wherein each cable is threaded through the sliding loop of a respective adjacent cable to form a ring adaptable for running under a rim of a plant pot and supporting the plant pot.

2. The plant pot hanger of claim 1, further comprising a tubing for each respective cable, wherein at least a portion of each cable runs through a respective tubing.

3. The plant pot hanger of claim 1, further comprising a silicon tubing for each respective cable, wherein at least a portion of each cable proximate a respective sliding loop runs through a respective tubing.

4. The plant pot hanger of claim 1, wherein the cable is made from SAE 304 stainless steel.

5. The plant pot hanger of claim 1, wherein two of the three or more cables constitute two halves of a single cable.

6. The plant pot hanger of claim 1, wherein two of the three or more cables constitute a loop and the two halves of a single cable.

7. The plant pot hanger of claim 1, further comprising a ferrule for securing together the first ends of the respective cables.

8. The plant pot hanger of claim 1, further comprising three or more cable locks to secure the sliding loops at the second ends of the respective cables.

9. A plant pot hanger comprising:
a sliding collar;
a first cable and a second cable;
a ferrule having a top end and a bottom end;
the second cable is configured to form a top loop and a third cable, wherein the first, second and third cables are threaded through the sliding collar;
the first, second and third cables and top loop are secured by the ferrule, wherein the top loop extends through the top end of the ferrule, and the first, second, and third cables extend through the bottom end of the ferrule;
a sliding loop is secured at an end of each respective cable; and
wherein the first cable is threaded through the sliding loop of the third cable, the second cable is threaded through the sliding loop of the first cable, and the third cable is threaded through the sliding loop of the second cable, to form a tri-sector ring adaptable for running under a rim of a plant pot and supporting the plant pot.

10. The plant pot hanger of claim 9, further comprising three tubings, wherein at least a portion of each cable runs through a corresponding tubing.

11. The plant pot hanger of claim 9, further comprising three silicon tubings, wherein at least a portion of each cable proximate a respective sliding loop runs through a corresponding tubing.

12. The plant pot hanger of claim 9, wherein the cable is made from SAE 304 stainless steel.

13. The plant pot hanger of claim 9 further comprising cable locks for securing the respective sliding loop at an end of each respective cable.

14. A plant pot hanger comprising:
a sliding collar;
a first cable having a first end and a second end and defining a middle portion, a first portion interposed between the first end and the middle portion, and a second portion interposed between the second end and the middle portion;
a second cable having a first end and a second end, wherein the second cable and the first portion and second portion of the first cable are threaded through the sliding collar;
a ferrule securing the first portion and second portion of the first cable together with the first end of the second cable such that the middle portion of the first cable forms a top loop extending from one end of the ferrule, and such that the first and second ends of the first cable and the second end of the second cable extend from an opposing end of the ferrule;
wherein the first and second ends of the first cable and the second end of the second cable form a sliding loop secured with a respective cable lock; and
wherein the first end of the first cable is threaded through the sliding loop of the second end of the second cable, the second end of the first cable is threaded through the sliding loop of the first end of the first cable, and the second end of the second cable is threaded through the sliding loop of the second end of the first cable, to form a tri-sector ring adaptable for running under a rim of a plant pot and supporting the plant pot.

15. The plant pot hanger of claim 14, further comprising:
a first tubing through which the first cable extends; and
a second tubing through which the second cable extends.

16. The plant pot hanger of claim 14, further comprising:
a first tubing through which the first portion of the first cable extends;
a second tubing through which the second portion of the first cable extends; and
a third tubing through which the second cable extends.

17. The plant pot hanger of claim 14, further comprising:
a first silicon tubing through which the first portion of the first cable proximate a sliding loop extends;
a second silicon tubing through which the second portion of the first cable proximate a sliding loop extends; and
a third silicon tubing through which the second cable proximate a sliding loop extends.

18. The plant pot hanger of claim 14, wherein the cable is made from SAE 304 stainless steel.

19. The plant pot hanger of claim 14 wherein the cable locks for securing the respective sliding loop at an end of each respective cable is at least one of ferrules, tack welds, and epoxy.

20. A plant pot hanger comprising:
a sliding collar;
a first cable having a first end and a second end and defining a middle portion, a first portion interposed between the first end and the middle portion, and a second portion interposed between the second end and the middle portion;
a second cable having a first end and a second end, wherein the second cable and the first portion and second portion of the first cable are threaded through the sliding collar;
first means for securing the first portion and second portion of the first cable together with the first end of the second cable such that the middle portion of the first cable forms a top loop extending from one end of the first means for securing, and such that the first and second ends of the first cable and the second end of the second cable extend from an opposing end of the first means for securing;
wherein the first and second ends of the first cable and the second end of the second cable each form a respective sliding loop secured with a respective second means for securing; and
wherein the first end of the first cable is slidably threaded through the sliding loop of the second end of the second cable, the second end of the first cable is slidably threaded through the sliding loop of the first end of the first cable, and the second end of the second cable is slidably threaded through the sliding loop of the second end of the first cable, to form a tri-sector ring adaptable for running under a rim of a plant pot and supporting the plant pot.
